(19) United States
(12) Patent Application Publication
(10) Pub. No.: US 2008/0208726 A1
(43) Pub. Date: Aug. 28, 2008

(54) Method and system for securing credit accounts

(75) Inventors: George K. Tsantes, Great Falls, VA (US); Andrew Gerry, Herndon, VA (US); Timothy Rohrbaugh, Haymarket, VA (US); Cheryl Kennedy, Ashburn, VA (US)

Correspondence Address: VENABLE LLP, P.O. BOX 34385, WASHINGTON, DC, 20043-9998, US

(73) Assignee: Intersections, Inc., Chantilly, VA (US)

(21) Appl. No.: 12/071,274

(22) Filed: Feb. 19, 2008

Related U.S. Application Data
(63) Continuation-in-part of application No. 11/515,385, filed on Sep. 5, 2006, now Pat. No. 7,333,635.
(60) Provisional application No. 60/713,363, filed on Sep. 2, 2005.

(51) Int. Cl. G06Q 40/00

(52) U.S. Cl. 705/35

(57) ABSTRACT

An enterprising identity thief may open new credit accounts in a consumer's name and then place a credit freeze on a consumer's credit file, thus making it more difficult to detect or remedy the identity theft. This problem may be solved by automatically requesting a security freeze at each of the three main credit bureaus upon the enrollment of a consumer with the service provider. The requesting of the security freeze may result in the credit bureau generating an identification code for the consumer at each of the credit bureaus. The service provider then may immediately request that the security freeze be removed. Accordingly, the consumer may gain control of the security freeze credentials from each credit bureau before the identity thief.

### BACKGROUND OF THE INVENTION

Today's modern society requires individuals to divulge personal identifying information in order to obtain such necessities as health insurance, loans, employment, and even cell phone service. Unfortunately, thieves harvesting this information have a low chance of getting caught despite the illegality of the activity. A recent study by Gartner, Inc. found that the identity thieves' risk of being caught is approximately 1 person out of 700 thieves. Identity theft is one of the fastest growing crimes in North America. Identity thieves can rob consumers of money, time, affordable credit, and even their reputation-yet the consumer may not even realize it.

Identity theft has been under reported for years. The Federal Trade Commission (FTC) reports that as many as one in every eight American adults and one in every four households has been victimized by identity thieves for five consecutive years. The reports indicate that there have been over nine million new victims of identity theft per year for two consecutive years with over 36 million new victims of identity theft in the past five years. Approximately ten million Americans in one year alone have fallen victim to this destructive crime. Identity theft has been the top consumer complaint to the FTC for five years in a row.

Although the rise of technology has been partly blamed for an increase in identity theft and fraud, many of the ways identity thieves obtain personal information remain decidedly low-tech. In fact, in February of 2004 the American Broadcasting Company (ABC) reported that the FTC estimated 400,000 individuals have had their mail stolen and subsequently became the victims of identity theft in just one year.

The cost of identity theft to consumers and businesses is astronomical and rising. The FTC reports that direct out-of-pocket losses to consumers was five billion dollars during 2005 alone and says businesses and financial institutions lost a staggering $48 billion during the same time period. Additionally, the repercussions of identity theft go far beyond the wallet for many individuals and businesses. Americans now spend almost three million hours resolving problems related to identity theft each year. As a result of the fraud, many victims report ongoing problems beyond direct financial loss including loan or insurance rejection, criminal investigation, or harassment by creditors.

Due to the myriad number of ways that identity thieves can access a consumer's private information, identity theft is very difficult to prevent. Private information can be accessed by stealing an individual's mail, wallet, etc. Additionally, online schemes are becoming much more prevalent. Phishing, pharming, and tacking have become commonplace in the online world. Moreover, there have been numerous security breaches not only at large corporations, but also at other institutions as well. Hospitals, universities, and other organizations have publicly reported that data on approximately 13.5 million consumers was lost or stolen in the first half of 2005 alone. Additionally, a recent survey of 163 companies found that 75 percent of these companies reported a serious security breach had occurred within the previous twelve-month period.

Although the loss of personal information is concerning, the critical damage occurs when that theft of personal information is used to defraud. Identity fraud may be defined as the use of another's identity. Identity fraud is a multi-faceted and evolving problem. It may surface as internet fraud, synthetic ID fraud, credit card and mortgage application fraud, non-credit card transactional fraud, and many others. The creation of new accounts and the takeover of existing accounts are among the most damaging methods used by identity thieves.

Security freezes are a relatively new means to combat identity theft. Security freezes are designed to prevent a credit reporting company from releasing a consumer's credit report for any purpose without the consumer's consent. A security freeze prevents the credit bureau from reporting a credit file to third parties, such as credit grantors or other agencies, except those exempted by law. Thus, the opening of new credits accounts without the consumer's approval may be prevented. Consumers can also request to temporarily lift a security freeze, globally or for access by a specific entity.

A security freeze can help prevent identity theft since most businesses will not issue new credit or loans to a consumer without first reviewing their credit report and/or credit score. If a consumer's credit file is frozen and an imposter applies for credit in that individual's name, a creditor likely would deny the imposter's application, preventing an instance of identity theft or identity fraud. In addition, if a request for credit is made on a frozen account, the credit bureau may be required to notify the consumer about the attempted access.

An enterprising identity thief may open new credit accounts in a consumer's name and then place a credit freeze on a consumer's credit file. The identity thief would thus have control over access to the consumer's credit reports. No one, including the consumer, could access the consumer's credit files without the codes held by the identity thief, thus making it more difficult to detect or remedy the identity theft.

Before placing a security freeze on a credit file, the consumer should consider the legitimate uses of credit reports beyond just the granting of credit. A security freeze may delay or possibly even prevent the consumer from getting credit, a cellular telephone, utility service, a security clearance for certain government or other positions, or obtaining various government licenses. Consumers must plan ahead due to the processing time with the credit bureaus.

When filing a security freeze with an individual credit bureau, this information is not shared with the other bureaus—unlike a Fraud Alert. With the security freeze, each bureau must be contacted directly to file a security freeze.

In contrast, the fraud alert messages notify potential credit grantors to thoroughly verify the individual's identification before extending credit in the consumer's name in case someone is using the consumer's information without their consent. Additionally, the fraud alert messages indicate that the account information may be compromised and may already be know to the fraudsters.

The security freeze process currently requires a written request or a form from the credit bureau and is processed via U.S. Mail. When a consumer initially activates the security freeze, the credit bureau will issue a unique identification code to the consumer that can be used to “thaw” or lift the security freeze for a particular creditor or for a specific amount of time. In order to remove the security freeze, the unique identification code must be provided to the credit bureau, even if the request is from a third party.

Under the laws of most states, it may take up to three business days to process the request to suspend or remove a freeze. The processing time may be even longer if the consumer lost the identification codes. The consumer controls the security freeze—for example, when it is temporary lifted or when it should be removed. Once the security freeze has attached, the consumer must contact the credit bureaus individually to request a lift of the security freeze in order to release the credit file to the identified credit grantor.

### SUMMARY OF THE INVENTION

Embodiments of the invention provide a method, comprising: receiving a request for unfreezing a consumer credit account with a credit bureau that has a security freeze placed on it, the request including an identification code; generating a release code based on the request at the service provider; providing the release code from the service provider to the consumer; receiving the release code at the service provider from a requestor; matching the release code with the request; obtaining a plurality of identification codes for the consumer's accounts having a security freeze from a respective plurality of credit bureaus based on the release code; submitting an unfreeze request from the service provider including the respective identification codes to the plurality of credit bureaus if the release code in the request matches a stored release code; receiving a confirmation of the unfreeze of the accounts from the credit bureaus; providing the confirmation to the requester.

Embodiments also provide a method, comprising: receiving a request to freeze a consumers credit accounts at credit bureaus at a service provider; requesting a security freeze from the service provider to a plurality of credit bureaus; receiving a respective identification code at the service provider for the consumer related to the security freeze from each of the plurality of credit bureaus; storing each of the identification codes at the service provider; generating a single security code associated with the identification codes for the consumer; providing the security code to the consumer.

Systems, such as computer systems and computer readable mediums, for performing the methods are also provided.

### BRIEF DESCRIPTION OF THE DRAWINGS

The foregoing and other features and advantages of the invention will be apparent from the following description of an embodiment of the invention as illustrated in the accompanying drawings, in which:

FIG. 1 depicts a process flow according to an embodiment of the present invention;

FIG. 2 depicts a process flow according to an embodiment of the present invention;

FIG. 3 depicts a process flow according to an embodiment of the present invention;

FIG. 4 depicts a process flow according to an embodiment of the present invention;

FIG. 5 depicts a process flow according to an embodiment of the present invention; and

FIG. 6 depicts a process flow according to an embodiment of the present invention.

### DETAILED DESCRIPTION OF THE INVENTION

Embodiments of the invention are discussed in detail below. In describing embodiments, specific terminology is employed for clarity. However, the invention is not intended to be limited to the specific terminology described. While specific exemplary embodiments are discussed, it should be understood that this is done for illustration purposes only. A person skilled in the relevant art will recognize that other components and configurations can be used without departing from the spirit and scope of the invention.

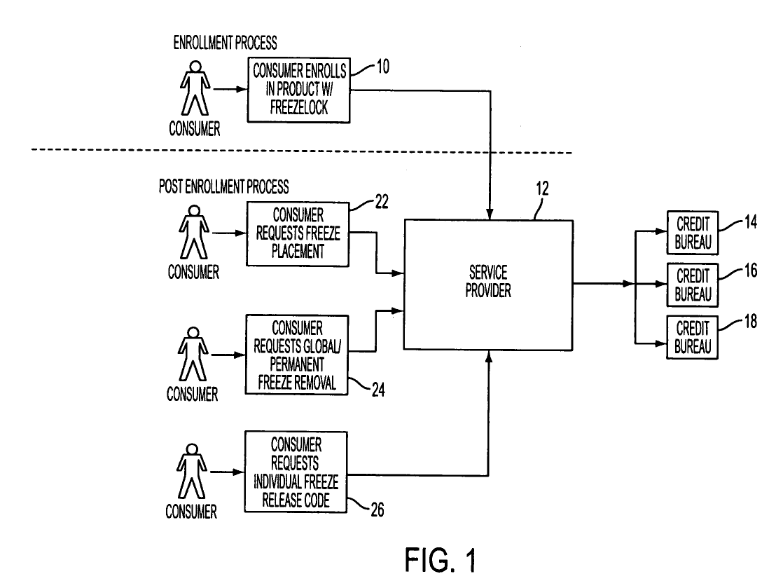

Embodiments of the invention provide a method and system that allows a consumer to control the placement or removal of a security freeze on their individual credit bureau files via a single service provider. The service provider may act as an intermediary between the consumer, the credit bureaus and/or credit requesting institutions. FIG. 1 illustrates an overview of an exemplary embodiment of the invention. The consumer may enroll with the service provider, block 10. During the enrollment process, the service provider may gather information specific to the needs of the service. For example, the service provider 12 may gather personal information from the consumer in order to establish an account for the consumer. The identity of the consumer may also be authenticated during the enrollment process.

There may be a number of different channels through which the individual can interact with the service provider. For example, the interaction may occur and information may be gathered by the telephone, by Internet, in person, or by other means. The enrollment and authentication may be performed as described in co-pending U.S. patent application Ser. No. 11/515,385, which is incorporated herein by reference. The consumer may be provided with a user name and password as part of enrollment. The user name and password may be used by the consumer for subsequent interactions with the service provider 12.

Once the enrollment is complete, a security freeze may be placed on the consumer's credit files at one or more of the three main credit bureaus 14, 16, 18. The consumer may request the service provider 12 to place the security freeze on the account or the request may be made automatically by the service provider 12 upon enrollment. The service provider 12 may handle interactions with each of the three main credit bureaus 14, 16, 18 to place the security freeze. For example, the service provider 12 may handle requests for a security freeze, block 22, handle a request for removal of a security freeze—both permanent or temporary, block 24, handle a request for a release code, block 26, and process new requests for security freezes. The service provider 12 may request the security freeze via direct interaction with one or more of the credit bureaus 14, 16, 18 based on information gathered during the enrollment and authentication processes. For example, the gathered information may include the individual's name, address, social security number or other information needed to distinguish one consumer from another.

Once the security freeze has been approved by a respective credit bureau, the credit bureau may issue an identification code for the consumer. The credit bureau typically requires an identification code in order to access the consumer's credit file at the credit bureau. The service provider 12 may securely store the identification codes from the credit bureaus 14, 16, 18.

The service provider 12 may generate a single security code for the consumer. The consumer may use this single security code to request placement or removal of security freezes. The security code may or may not be based on the identification codes provided by the credit bureaus 14, 16, 18. Thus, the consumer may need only remember and/or maintain a single code instead of a plurality of different codes. The consumer may also only need to interact with a single service provider 12 instead of a plurality of credit bureaus 14, 16, 18.

As noted above, an enterprising identity thief may open new credit accounts in a consumer's name and then place a credit freeze on a consumer's credit file, thus making it more difficult to detect or remedy the identity theft. Embodiments of the present invention may solve this problem by automatically requesting a security freeze at each of the three main credit bureaus 14, 16, 18 upon the enrollment of a consumer with the service provider 12. The requesting of the security freeze may result in the credit bureau generating an identification code for the consumer at each of the credit bureaus 14, 16, 18. The service provider 12 then may immediately request that the security freeze be removed. Accordingly, the consumer may gain control of the security freeze credentials from each credit bureau before the identity thief.

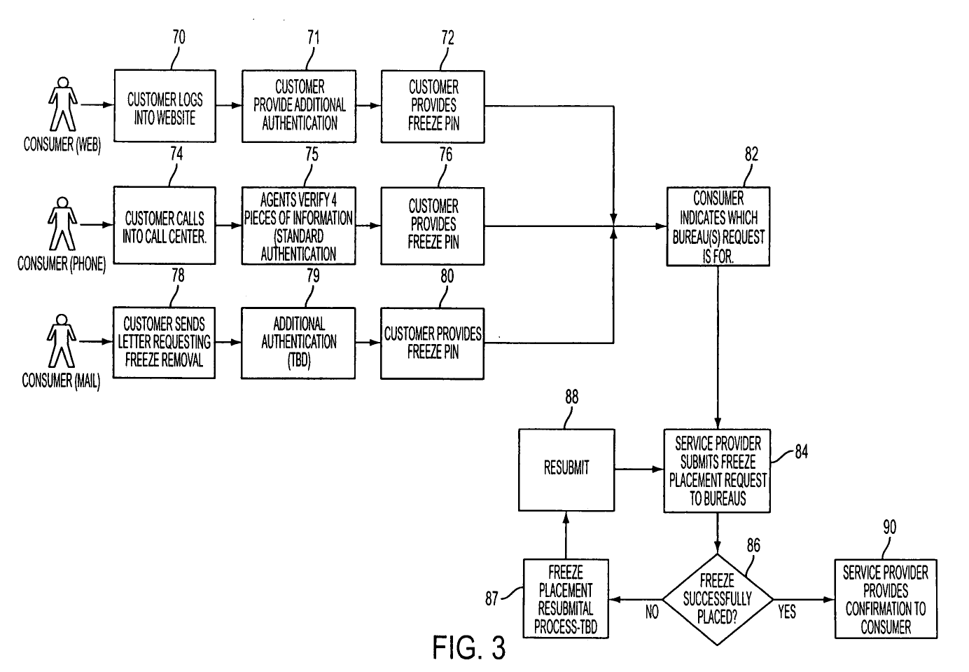

The consumer may be presented with a number of different options to implement the security freeze. The consumer may elect to have a security freeze placed immediately on their credit account; the consumer may elect to wait before implementing the security freeze; or the consumer may elect to have the security freeze placed and then immediately removed. The customer may then request the security freeze to be placed again at a later time, for example as shown in FIG. 3.

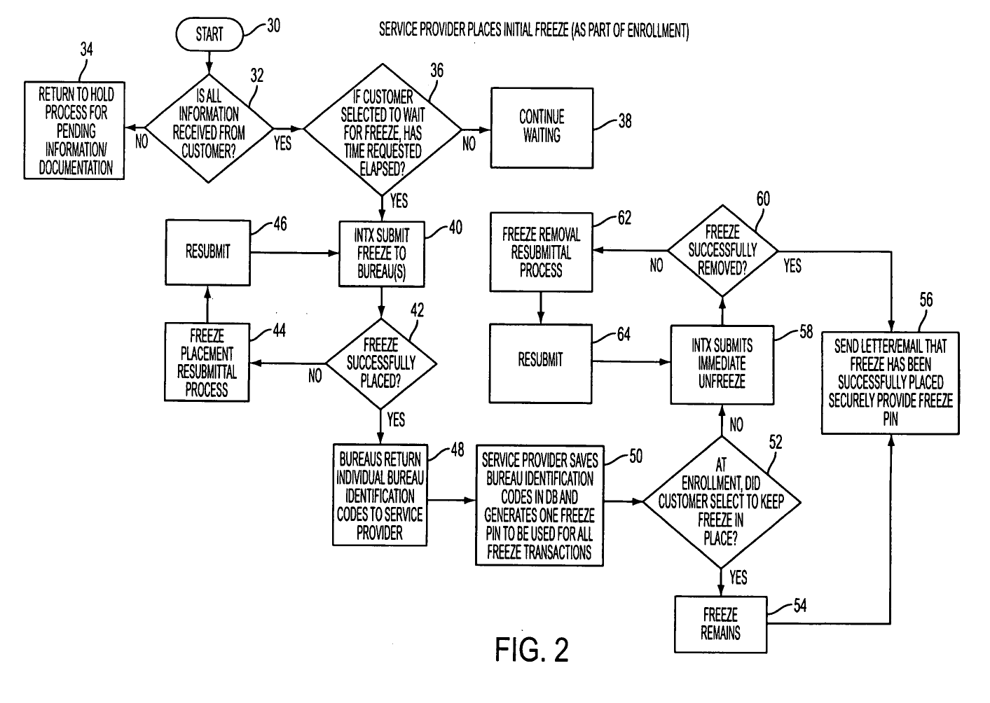

FIG. 3 illustrates three exemplary communication channels via which a consumer may interact with the service provider, via a website, blocks 70-72 a call center, blocks 76-78 and the mail, blocks 79-81. The consumer may be authenticated via whichever communicate channel is selected. When communicating via mail and the call center, an agent of the service provider may take part in the interaction, for example request and receiving information from the consumer or entering information into the service provider's systems. The request should include which credit bureau the request is for, block 82. The service provider 12 may request a security freeze and provide confirmation, blocks 84-90, in manner similar to that described in more detail below with reference to FIG. 2.

The example process of FIG. 2 relates to the option where the consumer elects to wait before implementing the security freeze, In the exemplary process, it is determined if all the required materials are received from the consumer and any elapsed time period has passed, blocks 30-38. For example, if the consumer has enrolled via postal mail, the application may be missing some documents. Also, supporting documentation, such as a utility bill to confirm the consumer's current residence may be required. The application may be processed and held until additional documentation arrives. Once the additional documentation is received, a check may be made to determine whether the requested time period has elapsed. If the time period has not elapsed, the security freeze is not requested. If the requested time period has elapsed, the service provider 12 may make a request for a security freeze to one or more of the credit bureaus 14, 16, 18, block 40. Note, if the request time period has elapsed but the consumer has not provided all necessary documentation, the freeze request process may not begin.

Depending on the particular credit bureau, the request to the credit bureaus 14, 16, 18 for a security freeze may require different information. The service provider 12 may gather the required information during enrollment. The service provider 12 may generate a single data set that satisfies the requirements of all of the credit bureaus 14, 16, 18 and provide the single data set to each of the credit bureaus 14, 16, 18 as the part of request for the security freeze. The service provider 12 may interact directly with each of the credit bureaus 14, 16, 18 to facilitate the making of the request for the security freeze.

After the request is made, the service provider 12 may wait for acknowledgment from the credit bureaus 14, 16, 18 to determine whether the security freeze was successfully placed on the consumer's credit file, block 42. If the service provider 12 does not receive a confirmation within a predetermined time or if the credit bureau indicates that the freeze was not placed successfully, the service provider 12 may resubmit the request for the security freeze, blocks 44-46. If the response from the credit bureau indicates some type of error such as missing information, the service provider 12 may automatically check for and correct the error. The service provider 12 may initiate processes to collect/correct data from customer as needed.

Once the security freeze is successfully placed on the consumer's credit files, each of the credit bureaus 14, 16, 18 may return confirmation along with a respective identification code for the consumer's account, block 48. Each of the credit bureaus 14, 16, 18 may provide its own identification code. This identification code is typically required by the credit bureau in order to access to the consumer's credit files, as well as to remove or temporarily suspend the security freeze. The service provider 12 may store the identification codes received from the credit bureaus 14, 16, 18, for example, in a secure database. The service provider 12 may generate a single personal identification number (PIN) for the consumer that is associated with the consumer's identification codes, block 50. The single PIN may used by the consumer for all of the consumer's security freeze transactions with the service provider 12.

If the consumer elects to keep the security freeze in place, no further interaction between the service provider 12 and the credit bureaus 14, 16, 18 may occur at this time, blocks 52-54. A notification may be sent to the consumer from the service provider 12 that the security freeze is in place. This communication may also include the single PIN generated by the service provider 12, block 56.

If the consumer elects to remove the security freeze, the service provider 12 may immediately request the removal of the security freeze from each of the three credit bureaus 14, 16, 18, blocks 58-64. The service provider 12 may provide the consumer's respective identification code to the respective credit bureau. Each of the credit bureaus 14, 16, 18 may have different requirements for requesting removal of a security freeze. The service provider 12 may generate a single request that complies with the requirements of all of the credit bureaus 14, 16, 18 and provide that request to each of the credit bureaus 14, 16, 18. Additionally, the service provider 12 may enter into an agreement with the credit bureaus 14, 16, 18 regarding the request process.

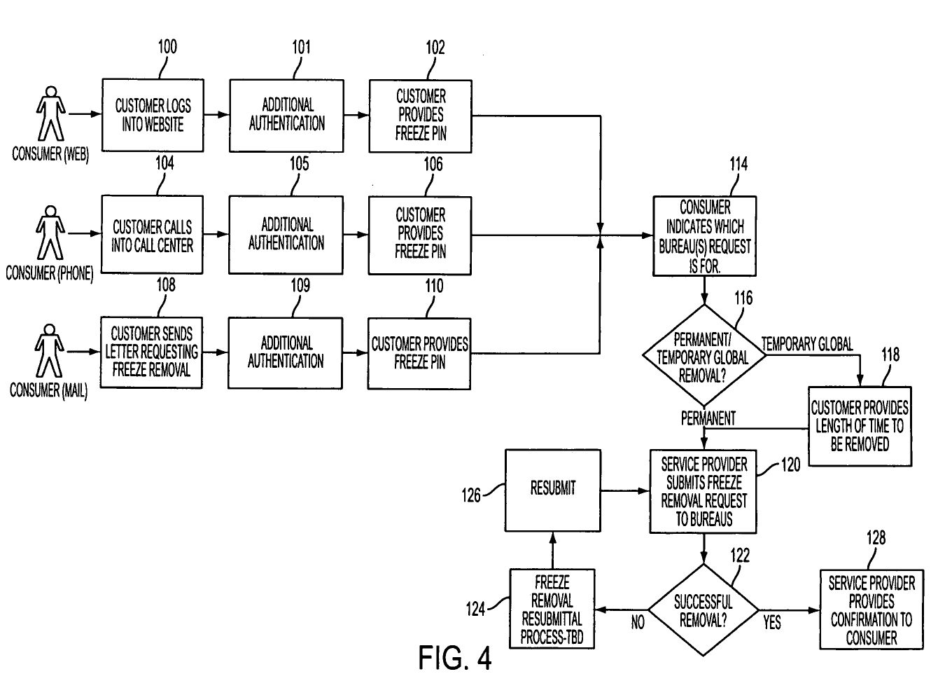

FIG. 4 illustrates an exemplary process for requesting the removal of a security freeze. Once a security freeze is in place, the security freeze must be removed, at least temporarily, in order for a credit provider to gain access to the consumer's credit reports and to determine their credit worthiness. For example, if the consumer is applying for a mortgage, the mortgagor is not able to access the consumer's credit reports and process their mortgage application unless the security freeze is removed. Consequently, the consumer may elect to have the security freeze removed, at least temporarily.

The consumer may interact directly with the service provider 12 to request the removal of a security freeze from one or more of their credit files with the credit bureaus 14, 16, 18 via any of the communication channels mentioned above. For example, the interaction may be via a website, a call center or the mail, blocks 100-110. The consumer may provide their PIN to the service provider 12 as part of the request. The request may also identify from which of the credit bureaus 14, 16, 18 to remove the security freeze, as well as whether the removal of the security freeze is permanent or temporary, blocks 114-116. If the request is temporary, the consumer should provide a length of time that a security freeze is to be removed, block 118.

The service provider 12 may obtain the identification codes for each of the consumer's credit files with each of the credit bureaus 14, 16, 18 based on the PIN. The service provider 12 may then directly interact with each of the credit bureaus 14, 16, 18 to remove the security freeze, blocks 120-126, for example, as discussed above with reference to FIG. 2. Once the credit bureau indicates to the service provider 12 that the security freeze was successfully removed, the service provider 12 may provide a confirmation to the consumer, block 128. If no confirmation of the removal of the security freeze is received by the service provider 12 from the credit bureaus 14, 16, 18, a resubmittal process may be performed.

Embodiments of the invention may also allow a consumer to permit approved parties to interact with the service provider 12 in having the security freeze removed. This may be desirable if a consumer intends to apply for credit and the credit grantor needs access to the consumer's credit report. The security freeze may be removed either permanently or temporarily. For example, the security freeze may be removed for a specific period of time, for example two weeks, during which the credit grantor has the opportunity to check the consumer's credit report. The service provider 12 may handle the removal of the security freeze. This may insure that only those credit grantors that the consumer desires have access to their credit reports know that the security freeze is removed and the time frame for accessing. This may also ensure that the correct credit grantor is chosen for removal. For example if the consumer does not know the correct credit grantor name used at the bureau, the wrong credit grantor or no credit grantor may be selected for credit file access, causing delay to the customer's application process. The service provider 12 may generate a release code that may be required for the removal of the security freeze.

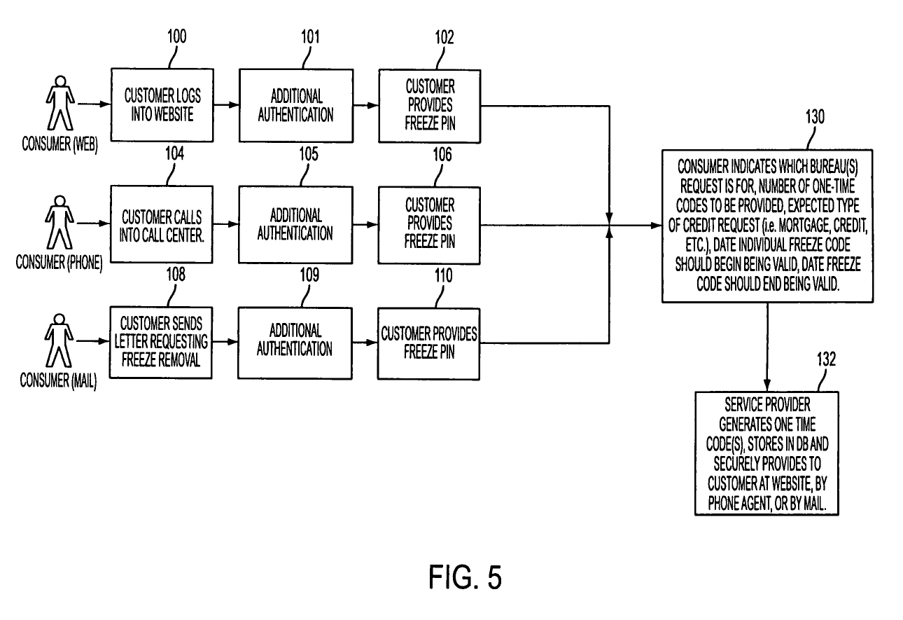

FIG. 5 illustrates an exemplary process for requesting a release code. As noted above, once the security freeze is placed, the consumer may request a release code. The consumer may interact with the service provider 12 to request the release code via any of the channels discussed above, blocks 100-110. In using any of the channels, the consumer should provide their PIN to the service provider 12. The request for a release code may also include additional information, such as which credit bureaus 14, 16, 18 the request is for, a number of release codes to be provided, a type of credit request, the dates the release code should be valid for, the party that may be making the credit account inquiry, and other account-related information, block 130. The service provider 12 may process the request and generate a one-time code as the release code. The service provider 12 may store the release code in the secure database and also provide the release code to the consumer, for example, via a secure communication channel, block 132. The consumer may then provide the release code to the desired entity, such as a credit grantor. The one-time release code may have an expiration date before which it must be used.

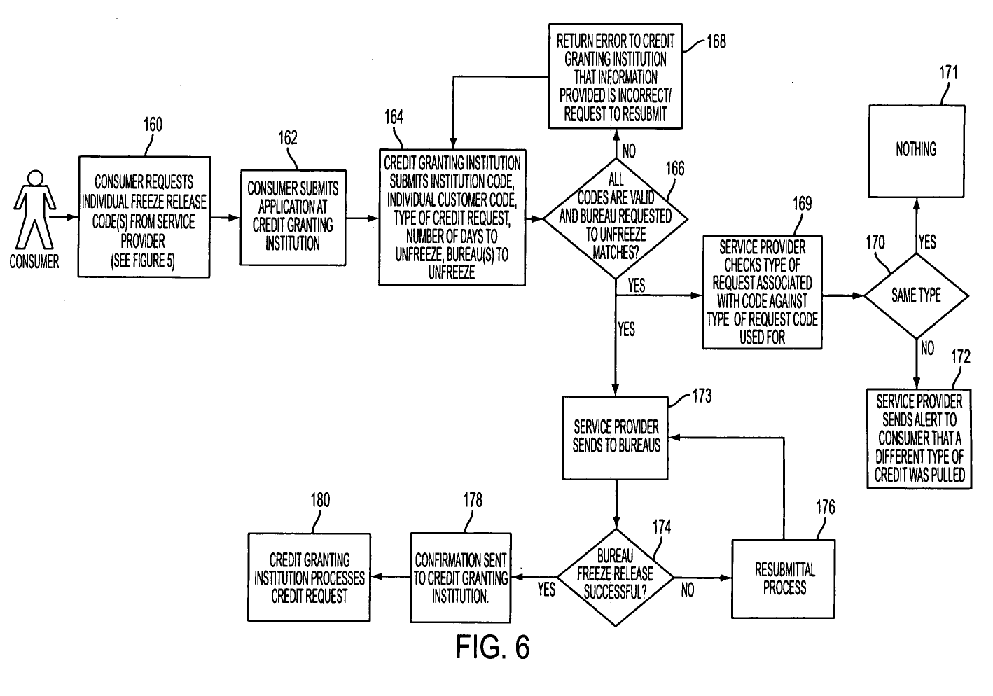

FIG. 6 illustrates an exemplary embodiment of a process in which a third party such as the credit grantor may request removal of the security freeze. Although described in the context of a credit grantor, the process may also apply to employers, utilities, government agencies, etc. A consumer may request a release code and apply for credit with the credit grantor. For additional security purposes, the credit grantor may be required to register with the service provider 12. The service provider 12 may perform an enrollment and authentication process for the credit grantor. This process may be similar to the enrollment and authentication process for the consumer. Once enrolled, the credit grantor may be provided an institution code that identifies the credit grantor to the service provider 12. The credit grantor may already be enrolled with the service provider 12, in which case enrollment may be bypassed.

The credit granting institution may interact with the service provider 12 to request the removal of the security freeze, block 164. The request may be made by any of the communication channels discussed above. The request from the credit grantor for removal of a security freeze should include both the release code as well as the institution code—although the institution code may be optional. The more information that is provided in the request from the credit grantor, the more secure the removal process. For example, the credit granting institution may provide their institution code, a release code, a type of credit request made by the consumer, a time period for the security freeze to be removed, as well as at which credit bureaus 14, 16, 18 the security freeze should be removed. The information submitted by the credit grantor may be compared with the information provided by the consumer when requesting the release code to determine whether to proceed with the removal of the security freeze, blocks 166-168.

For example, the credit granting institution may submit a request including its institution code, the release code, and an indication that the type of credit requested was a mortgage. The consumer, in their request for the release code, may have indicated that the type of credit request is a credit card. In comparing the information and the request from the consumer to the information in a request from the credit grantor, the service provider 12 may detect the discrepancy between the type of credit requests. Depending on the type of discrepancy between the requests, the freeze removal process may end or the consumer may be sent an alert about the discrepancy, for example, that a different type of credit was pulled from their credit account, blocks 169-172. The rules for granting may vary based on a specific implementation.

If the freeze removal process is to proceed, the service provider 12 may obtain the identification codes for the consumer and request the removal of the security freeze from the appropriate credit bureaus 14, 16, 18, blocks 173-176, for example as described above. Once confirmation of the removal of the security freeze is received and the service provider 12, a confirmation may be sent to the credit granting institution that the security freeze has been removed, block 178. The credit granting institution may then process the credit request and proceed with their transaction with the consumer, block 180. Once the specified time period for the removal of the security freeze has expired, the service provider 12 may contact the credit bureaus 14, 16, 18 to place the security freeze on the consumer's credit account again. The service provider 12 may have an automated replacement submission process or the bureau may have an automated process to replace the freeze based on the initial request set by the service provider 12. If no confirmation of the removal of the security freeze is received by the service provider 12 from the credit bureaus 14, 16, 18, a resubmittal process may be performed.

The embodiments illustrated and discussed in this specification are intended only to teach those skilled in the art the best way known to the inventors to make and use the invention. Nothing in this specification should be considered as limiting the scope of the present invention. The above-described embodiments of the invention may be modified or varied, and elements added or omitted, without departing from the invention, as appreciated by those skilled in the art in light of the above teachings. For example, the order in which the steps are performed may be varied as long as the above-described dependencies are maintained. It is therefore to be understood that, within the scope of the claims and their equivalents, the invention may be practiced otherwise than as specifically described.

We claim:

1. A method, comprising:
receiving a request for unfreezing a consumer credit account with a credit bureau that has a security freeze placed on it, the request including an identification code;
generating a release code based on the request at the service provider;
providing the release code from the service provider to the consumer;
receiving the release code at the service provider from a requestor;
matching the release code with the request;
obtaining a plurality of identification codes for the consumer's accounts having a security freeze from a respective plurality of credit bureaus based on the release code;
submitting an unfreeze request from the service provider including the respective identification codes to the plurality of credit bureaus if the release code in the request matches a stored release code;
receiving a confirmation of the unfreeze of the accounts from the credit bureaus;
providing the confirmation to the requester.

2. The method of claim 1, further comprising:
receiving a notification of an inquiry into the consumers credit file; and
notifying the consumer of the inquiry.

3. The method of claim 1, further comprising authenticating an identity of the consumer prior to providing the release code.

4. The method of claim 1, further comprising:
providing an institution code to the requester;
receiving the institution code along with the release code; and
verifying the institution code.

5. The method of claim 1, wherein the request and the unfreeze request includes a type of credit request; and verifying the type of credit request in the request and the unfreeze request match; and notifying the consumer if the type of credit request in the request and the unfreeze request do not match.

6. The method of claim 1, wherein the unfreeze request includes at least one an institution code, individual customer code, type of credit request, time period to unfreeze, or bureau to unfreeze.

7. The method of claim 1, wherein the request includes at least one a credit bureau, number of release codes, type of credit request, time period for release code validity.

8. The method of claim 1, further comprising denying the unfreeze request if the unfreeze request is received outside of the predetermined time period.

9. The method of claim 1, wherein the request is provided directly to the credit bureau.

10. A method, comprising:
receiving a request to freeze a consumers credit accounts at credit bureaus at a service provider;
requesting a security freeze from the service provider to a plurality of credit bureaus;
receiving a respective identification code at the service provider for the consumer related to the security freeze from each of the plurality of credit bureaus;
storing each of the identification codes at the service provider;
generating a single security code associated with the identification codes for the consumer;
providing the security code to the consumer.

11. The method of claim 10, further comprising:
receiving enrollment information from the consumer;
authenticating the enrollment information; and
enrolling the consumer in the program if the enrollment information is authenticated.

12. The method of claim 10, wherein the requesting the security freeze comprises providing each of the credit bureaus with their required information.

13. The method of claim 10, further comprising providing the request directly to the credit bureaus

14. The method of claim 10, further comprising generating a single set of data that complies with each of the credit bureaus requirements and providing the same set of data to each of the credit bureaus.

15. The method of claim 10, further comprising;
receiving a request to remove the security freeze, the request including the consumer's single security code associated with the consumer's identification code;
determining the identification code for the credit bureaus based on the code;
providing a request to remove the security freeze directly to the respective credit bureaus including the respective identification codes;
receiving verification of the removal of the security freeze from the credit bureaus; and
notifying the consumer of the completion of the request.

16. A computer-readable medium comprising software, which when executed by a computer system causes the computer system to perform operations, the operations comprising:
receiving a request for unfreezing a consumer credit account with a credit bureau that has a security freeze placed on it, the request including an identification code;
generating a release code based on the request at the service provider;
providing the release code from the service provider to the consumer;
receiving the release code at the service provider from a requestor;
matching the release code with the request;
obtaining a plurality of identification codes for the consumer's accounts having a security freeze from a respective plurality of credit bureaus based on the release code;
submitting an unfreeze request from the service provider including the respective identification codes to the plurality of credit bureaus if the release code in the request matches a stored release code;
receiving a confirmation of the unfreeze of the accounts from the credit bureaus;
providing the confirmation to the requestor.

17. The computer-readable medium of claim 16, further comprising code for:
receiving a notification of an inquiry into the consumers credit file; and
notifying the consumer of the inquiry.

18. The computer-readable medium of claim 16, further comprising code for authenticating an identity of the consumer prior to providing the release code.

19. The computer-readable medium of claim 16, further comprising code for:
providing an institution code to the requestor;
receiving the institution code along with the release code; and
verifying the institution code.
